(19) United States
(12) Patent Application Publication
(10) Pub. No.: US 2005/0187130 A1
(43) Pub. Date: Aug. 25, 2005

(54) Granular laundry detergent composition comprising an anionic detersive surfactant, and low levels of, or no, zeolite builders and phosphate builders

(76) Inventors: Alan Thomas Brooker, Newcastle upon (GB); Nigel Patrick Somerville Roberts, Newcastle upon (GB); John Peter Eric Muller, Newcastle upon (GB); Stuart Andrew Caldwell, Northumberland (GB); Mark Allen Smerznak, Tyne & Wear (GB); Nicola Ethel Davidson, Newcastle upon (GB); Kevin Lee Kott, Newcastle upon (GB); Jason Christopher King, Cincinnati, OH (US); Doris Appleby, Newcastle upon (GB)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 11/050,393

(22) Filed: Feb. 3, 2005

Related U.S. Application Data
(60) Provisional application No. 60/547,033, filed on Feb. 23, 2004.

(51) Int. Cl. C11D 17/00

(52) U.S. Cl. 510/445

(57) ABSTRACT

The present invention relates to a granular laundry detergent composition comprising: (i) from 8 wt % to 55 wt % anionic detersive surfactant; and (ii) from 2 wt % to 8 wt % non-ionic detersive surfactant; and (iii) from 0 wt % to 4 wt % zeolite builder; and (iv) from 0 wt % to 4 wt % phosphate builder; and (v) optionally an enzyme, preferably a protease in an amount of at least 11 mg, preferably at least 15 mg, active protease per 100 g of the composition.

CROSS REFERENCE TO RELATED APPLICATION

This application claims the benefit of U.S. Provisional Application No. 60/547033, filed 23 Feb. 2004.

### FIELD OF THE INVENTION

The present invention relates to granular detergent compositions comprising an anionic detersive surfactant.

### BACKGROUND

Granular laundry detergent compositions need to have a good fabric-cleaning performance and good dispensing and dissolution profiles. Granular laundry detergent compositions comprise anionic detersive surfactants in order to provide a good fabric-cleaning performance. However, anionic detersive surfactants are capable of complexing with free cations, such as calcium and magnesium cations, that are present in the wash liquor in such a manner as to cause the anionic detersive surfactant to precipitate out of solution, which leads to a reduction in the anionic detersive surfactant activity. In extreme cases, these water-insoluble complexes may deposit onto the fabric resulting in poor whiteness maintenance and poor fabric integrity benefits. This is especially problematic when the laundry detergent composition is used in hard-water washing conditions when there is a high concentration of calcium cations.

The anionic detersive surfactant's tendency to complex with free cations in such a manner as precipitate out of solution is mitigated by the presence of builders, such as zeolite builders and phosphate builders, which have a high binding constant with cations such as calcium and magnesium cations. These builders sequester free calcium and magnesium cations and reduce the formation of these undesirable complexes.

However, zeolite builders are water-insoluble and their incorporation in laundry detergent compositions leads to poor dissolution of the laundry detergent composition and can also lead to undesirable residues being deposited on the fabric. In addition, detergent compositions that comprise high levels of zeolite builder form undesirable cloudy wash liquors upon contact with water. Whilst phosphate builders allegedly do not have favourable environmental profiles and their use in laundry detergent compositions is becoming less common; for example, due to phosphate legislation in many countries.

There remains a need for a granular laundry detergent composition comprising an anionic detersive surfactant having a good anionic detersive surfactant activity, a good fabric-cleaning performance, a good environmental profile, and good dispersing and good dissolution profiles.

### SUMMARY

The present invention overcomes the above problem by providing a granular laundry detergent composition comprising:(i) from 8 wt % to 55 wt % anionic detersive surfactant; and

(ii) from 2 wt % to 8 wt % non-ionic detersive surfactant; and (iii) from 0 wt % to 4 wt % zeolite builder; and (iv) from 0 wt % to 4 wt % phosphate builder; and

(v) optionally an enzyme, preferably a protease in an amount of at least 11 mg, preferably at least 15 mg, active protease per 100 g of the composition.

### DETAILED DESCRIPTION

The granular laundry detergent composition comprises from 8 wt % to 55 wt %, preferably from 8 wt % to 20 wt % anionic detersive surfactant. It may be preferred for the composition to comprise from 8 wt % to 16 wt %, or from 8 wt % to 12 wt % anionic detersive surfactant. This may be especially preferred if the composition comprises from 4 wt % to 6 wt % non-ionic detersive surfactant. It may be preferred that in this embodiment of the present invention, the weight ratio of anionic detersive surfactant to non-ionic detersive surfactant is in the range of from 0.5:1 to 2:1. Alternatively, the composition may preferably comprise higher levels of anionic detersive surfactant, such as from 10 wt % to 20 wt %, or from 10 wt % to 16 wt % anionic detersive surfactant. This may be especially preferred if the composition comprises from 2 wt % to 4 wt % non-ionic detersive surfactant. It may be preferred that in this embodiment of the present invention, the weight ratio of anionic detersive surfactant to non-ionic detersive surfactant is in the range of from 4:1 to 6:1.

The anionic detersive surfactant can be an alkyl sulphate, an alkyl sulphonate, an alkyl phosphate, an alkyl phosphonate, an alkyl carboxylate or any mixture thereof. The anionic surfactant can be selected from the group consisting of: C₁₀-C₁₈ alkyl benzene sulphonates (LAS); C₁₀-C₂₀ primary, branched-chain and random alkyl sulphates (AS), preferred are linear alkyl sulphates, typically having the following formula:
CH₃(CH₂)ₓCH₂—OSO₃³¹ M⁺
wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

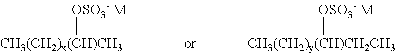

wherein, M is hydrogen or a cation which provides charge neutrality, preferred cations are sodium and ammonium cations, wherein x is an integer of at least 7, preferably at least 9, y is an integer of at least 8, preferably at least 9; C₁₀-C₁₈ alkyl alkoxy carboxylates; mid-chain branched alkyl sulphates as described in more detail in U.S. Pat. Nos. 6,020,303 and 6,060,443; modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548; methyl ester sulphonate (MES); alpha-olefin sulphonate (AOS) and mixtures thereof. Preferred anionic detersive surfactants are selected from the group consisting of: linear or branched, substituted or unsubstituted, C₁₂₋₁₈ alkyl sulphates; linear or branched, substituted or unsubstituted, C₁₀₋₁₃ alkylbenzene sulphonates, preferably linear C₁₀₋₁₃ alkylbenzene sulphonates; and mixtures thereof. Highly preferred are linear C₁₀₋₁₃ alkylbenzene sulphonates that are obtained by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

It may be preferred for the anionic detersive surfactant to be structurally modified in such a manner as to cause the anionic detersive surfactant to be more calcium tolerant and less likely to precipitate out of the wash liquor in the presence of free calcium cations. This structural modification could be the introduction of a methyl or ethyl moiety in the vicinity of the anionic detersive surfactant's head group, as this can lead to a more calcium tolerant anionic detersive surfactant due to steric hindrance of the head group, which may reduce the anionic detersive surfactant's affinity for complexing with free calcium cations in such a manner as to precipitate out of solution. Other structural modifications include the introduction of functional moieties, such as an amine moiety, in the alkyl chain of the anionic detersive surfactant; this can lead to a more calcium tolerant anionic detersive surfactant because the presence of a functional group in the alkyl chain of an anionic detersive surfactant may mininise the undesirable physicochemical property of the anionic detersive surfactant to form a smooth crystal structure in the presence of free calcium cations in the wash liquor. This may reduce the tendency of the anionic detersive surfactant to precipitate out of solution.

The anionic detersive surfactant is preferably in particulate form, such as an agglomerate, a spray-dried powder, an extrudate, a bead, a noodle, a needle or a flake. The anionic detersive surfactant, or at least part thereof, may be in a co-particulate admixture with a non-ionic detersive surfactant, this co-particulate admixture may preferably be in spray-dried form. Preferably, the anionic detersive surfactant, or at least part thereof, is in agglomerate form; the agglomerate preferably comprising at least 20%, by weight of the agglomerate, of an anionic detersive surfactant, more preferably from 20 wt % to 65 wt %, by weight of the agglomerate, of an anionic detersive surfactant. It may be preferred for part of the anionic detersive surfactant to be in the form of a spray-dried powder (e.g. a blown powder), and for part of the anionic detersive surfactant to be in the form of a non-spray-dried powder (e.g. an agglomerate, or an extrudate, or a flake). It may be preferred for a linear alkylbenzene sulphonate to be in a co-particulate admixture with soap, this co-particulate admixture may preferably be in spray-dried form.

The composition comprises from 2 wt % to 8 wt % non-ionic detersive surfactant. Preferably the composition comprises from 2 wt % to 6 wt % non-ionic detersive surfactant. It may be preferred for the composition to comprise low levels of non-ionic detersive surfactant, such as from 2 wt % to 4 wt % non-ionic detersive surfactant. Alternatively, it may be preferred for the composition to comprise high levels of non-ionic detersive surfactant, such as from 4 wt % to 6 wt % non-ionic detersive surfactant.

The non-ionic detersive surfactant can be selected from the group consisting of: C₁₂-C₁₈ alkyl ethoxylates, such as, NEODOL® non-ionic surfactants from Shell; C₆-C₁₂ alkyl phenol alkoxylates wherein the alkoxylate units are ethyleneoxy units, or propyleneoxy units, or a mixture thereof; C₁₂-C,₁₈ alcohol and C₆-C,₁₂ alkyl phenol condensates with ethylene oxide/propylene oxide block polymers such as Pluronic® from BASF; C₁₄-C₂₂ mid-chain branched alcohols, BA, as described in more detail in U.S. Pat. No. 6,150,322; C₁₄-C₂₂ mid-chain branched alkyl alkoxylates, BAEₓ, wherein x =from 1 to 30, as described in more detail in U.S. Pat Nos. 6,153,577, 6,020,303 and 6,093,856; alkylpolysaccharides as described in more detail in U.S. Pat. No. 4,565,647, specifically alkylpolyglycosides as described in more detail in U.S. Pat. Nos.4,483,780 and 4,483,779; polyhydroxy fatty acid amides as described in more detail in U.S. Pat. No. 5,332,528, WO 92/06162, WO 93/19146, WO 93/19038, and WO 94/09099; ether capped poly(oxyalkylated) alcohol surfactants as described in more detail in U.S. Pat. No. 6,482,994 and WO 01/42408; and mixtures thereof.

The non-ionic detersive surfactant could be an alkyl polyglucoside and/or an alkyl alkoxylated alcohol. Preferably the non-ionic detersive surfactant is a linear or branched, substituted or unsubstituted C₈-₁₈ alkyl ethoxylated alcohol having an average degree of ethoxylation of from 1 to 10.

The non-ionic detersive surfactant not only provides additional greasy soil cleaning performance but may also increase the anionic detersive surfactant activity by making the anionic detersive surfactant less likely to precipitate out of solution in the presence of free calcium cations. Preferably, the weight ratio of anionic detersive surfactant to non-ionic detersive surfactant is in the range of from 0.5:1 to 20: 1, more preferably from 0.5:1 to 10: 1, or from 0.5:1 to 6:1.

The non-ionic detersive surfactant, or at least part thereof, can be incorporated into the composition in the form of a liquid spray-on, wherein the non-ionic detersive surfactant, or at least part thereof, in liquid form (e.g. in the form of a hot-melt) is sprayed onto the remainder of the composition. The non-ionic detersive surfactant, or at least part thereof, may be in particulate form, and the non-ionic detersive surfactant, or at least part thereof, may be dry-added to the remainder of the composition. The non-ionic surfactant, or at least part thereof, may be in the form of a co-particulate admixture with a solid carrier material, such as carbonate salt, sulphate salt, burkeite, silica or any mixture thereof.

The non-ionic detersive surfactant, or at least part thereof, may be in a co-particulate admixture with either an anionic detersive surfactant or a cationic detersive surfactant. However the non-ionic detersive surfactant, or at least part thereof, is preferably not in a co-particulate admixture with both an anionic detersive surfactant and a cationic detersive surfactant. The non-ionic detersive surfactant, or at least part thereof, may be agglomerated or extruded with either an anionic detersive surfactant or a cationic detersive surfactant. The non-ionic detersive surfactant, or at least part thereof, may be in spray-dried powder form, optionally the non-ionic detersive surfactant, or at least part thereof, may be spray-dried with an anionic detersive surfactant. The non-ionic detersive surfactant, or at least part thereof, may be in a co-particulate admixture with soap, this co-particulate admixture may preferably be in non-spray-dried form, such as an extrudate or an agglomerate.

The composition may comprise from 0.5 wt % to 6 wt % cationic detersive surfactant. The composition may comprises from 0.5 wt % to 4 wt %, or from 1% to 3 wt %, or even from 1 wt % to 2 wt % cationic detersive surfactant Suitable cationic detersive surfactants are alkyl pyridinium compounds, alkyl quaternary ammonium compounds, alkyl quaternary phosphonium compounds, and alkyl ternary sulphonium compounds. The cationic detersive surfactant can be selected from the group consisting of: alkoxylate quaternary ammonium (AQA) surfactants as described in more detail in U.S. Pat. No. 6,136,769; dimethyl hydroxyethyl quaternary ammonium compounds as described in more detail in U.S. Pat. No. 6,004,922; polyamine cationic surfactants as described in more detail in WO 98/35002, WO 98/35003, WO 10 98/35004, WO 98/35005, and WO 98/35006; cationic ester surfactants as described in more detail in U.S. Pat. NOs. 4,228,042, 4,239,660, 4,260,529 and 6,022,844; amino surfactants as described in more detail in U.S. Pat. No. 6,221,825 and WO 00/47708, specifically amido propyldimethyl amine; and mixtures thereof. Preferred cationic detersive surfactants are quaternary ammonium compounds having the general formula:
(R)(R¹)(R²)(R³)N⁺X³¹

wherein, R is a linear or branched, substituted or unsubstituted C₆₋₁₈ alkyl or alkenyl moiety, R¹ and R² are independently selected from methyl or ethyl moieties, R³ is a hydroxyl, hydroxymethyl or a hydroxyethyl moiety, X is an anion which provides charge neutrality, preferred anions include halides (such as chloride), sulphate and sulphonate.

Preferred cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

The cationic detersive surfactant provides additional greasy soil cleaning performance. However, the cationic detersive surfactant may increase the tendency of the anionic detersive surfactant to precipitate out of solution. Preferably, the cationic detersive surfactant and the anionic detersive surfactant are present in the composition in the form of separate particles. This minimises any effect that the cationic detersive surfactant may have on the undesirable precipitation of the anionic detersive surfactant, and also ensures that upon contact with water, the resultant wash liquor is not cloudy. Preferably, the weight ratio of anionic detersive surfactant to cationic detersive surfactant is in the range of from 5:1 to 25: 1, more preferably from 5:1 to 20:1 or from 6:1 to 15: 1, or from 7:1 to 10: 1, or even from 8:1 to 9:1.

The composition may comprise additional adjunct detersive surfactants such as zwitterionic detersive surfactants and/or amphoteric detersive surfactants.

The composition comprises from 0 wt % to 4 wt % zeolite builder. The composition preferably comprises from 0 wt % to 3 wt %, or from 0 wt % to 2 wt %, or from 0 wt % to lwt % zeolite builder. It may even be preferred for the composition to be free from zeolite builder.

This is especially preferred if it is desirable for the composition to be very highly soluble. In addition, this is highly preferred if the composition, upon contact with water, is to form a transparent wash liquor. Zeolite builders include zeolite A, zeolite X, zeolite P and zeolite MAP.

The composition comprises from 0 wt % to 4 wt % phosphate builder. The composition preferably comprises from 0 wt % to 3 wt %, or from 0 wt % to 2 wt %, or from 0 wt % to 1 wt % phosphate builder. It may even be preferred for the composition to be free from phosphate builder. This is especially preferred if it is desirable for the composition to have a very good environmental profile. Phosphate builders include sodium tripolyphosphate.

The composition may comprise adjunct builders other than the zeolite builder and phosphate builder. Preferred adjunct builders are water-soluble adjunct builders. Adjunct builders are preferably selected from the group consisting of: sodium carbonate; citric acid and/or water-soluble salts thereof including sodium citrate; sulphamic acid and/or water-soluble salts thereof; polymeric polycarboxylates such as co-polymers of acrylic acid and maleic acid, or polyacrylate. It may be preferred for the composition to comprise very low levels of water-insoluble builders, such as zeolite A zeolite X, zeolite P and zeolite MAP, whilst comprising relatively high levels of water-soluble adjunct builders, such as sodium carbonate, sulphamic acid and citric acid.

It may be preferred for the weight ratio of sodium carbonate to zeolite builder to be at least 5: 1, preferably at least 10: 1, or at least 15:1, or at least 20:1 or even at least 25:1.

The composition preferably comprises a protease, preferably the composition comprises at least 11 mg of active protease per 100 g of composition. Preferably, the composition comprises at least 15 mg, or at least 20 mg, or even at least 30 mg of active protease per 100 g of composition. The protease may comprise a calcium binding site. The protease may show improved stability and/or activity in the presence of high levels of free calcium cations present in the wash liquor. By incorporating the protease into the composition, the cleaning performance of the composition is improved, and any reduction in the cleaning performance of the composition due to the low levels of, or lack of, zeolite builders and phosphate builders, which lead to a reduction in the anionic detersive surfactant activity, is mitigated by the increased stability and/or activity of the protease. Preferred proteases include: subtilisins from Bacillus [e.g. subtilis, lentus, licheniformis, amyloliquefaciens (BPN, BPN′), alcalophilus] that are sold under the tradenames Esperase®, Alcalase®, Everlase® and Savinase® supplied by Novozymes; proteases supplied by Genencor under the tradenames FN2®, FN3® and FN4®; and BLAP and/or variants thereof. Suitable proteases are described in more detail in EP 130 756, WO 91/06637, WO 95/10591 and WO 99/20726.

The composition preferably also comprises amylase, preferably in an amount of at least 4 mg, preferably 6 mg, or at least 10 mg, or at least l5 mg, or even at least 20 mg or even 30 mg of active amylase per 100 g of composition. The amylase may comprise a calcium binding site. Analogous to the protease, the amylase may also show improved stability and/or activity, especially stability, in the presence of high levels of free calcium cations present in the wash liquor. The incorporation of amylase into the composition improves the cleaning performance. Preferred amylases include: amylases supplied by Novo Industries A/A under the tradenames Natalase®, Duramyl®, Termamyl®, Ban®, Fungamyl®; amylases supplied by Genencor under the tradename Purafect Ox Am®; and mixtures thereof. The amylase can be an α-amylase or a β-amylase. Suitable amylases are described in more detail in WO 94/02597 and WO 96/23873.

The composition may also comprise lipase, preferably in an amount of at least 5 mg, preferably at least 7 mg, or at least 10 mg, or at least 15 mg, or at least 20 mg, or even at least 30 mg of active lipase per 100 g of composition. The lipase may comprise a calcium binding site. Analogous to both the protease and the amylase, the lipase may also show improved stability and/or activity, especially activity, in the presence of high levels of free calcium cations present in the wash liquor. The incorporation of lipase into the composition improves the cleaning performance. Preferred lipases include those produced by Pseudomonas and Chromobacter groups. Preferred lipases are supplied by Novozymes under the tradenames. Lipolase®, Lipolase Ultra®, Lipoprime® and Lipex®. Other suitable lipases are cutinases and esterases.

The composition may also comprise other enzymes such as: cellulases, including bacterial or fungal cellulases such as cellulases produced by Humicola insolens, and in particular cellulases supplied by Novo Industries A/A under the tradenames Carezyme®, Endo A®, other suitable cellulases are the EGIII cellulases from Trichoderma longibrachiatum; carbohydrases, including mannanase such as that described in more detail in U.S. Pat. No. 6,060,299, pectate lyase such as that described in more detail in WO 99/27083, cyclomaltodextringlucanotransferase such as that described in more detail in WO 96/33267, xyloglucanase such as that described in more detail in WO 99/02663; bleaching enzymes such as peroxidases, laccases, oxygenases (e.g. catechol 1,2 dioxygenase), lipoxygenase that is described in more detail in WO 95/26393, and non-heme haloperoxidases.

It may be preferred for the weight ratio of protease to lipase to be at least 1.5:1, preferably at least 2:1, or even at least 3: 1. It may be preferred for the weight ratio of protease to amylase to be in the range of from 1.5:1 to 2.3:1, or from 1.7:1 to 2:1. It may be preferred for the weight ratio of protease to amylase to be at least 3.1:1, or at least 3.5:1, or at least 4:1, or even at least 5:1.

The composition preferably comprises carbonate salt. The composition may comprise from 1 wt % to 50 wt % carbonate salt. It may be preferred for the composition to comprise from 5 wt % to 50 wt %, or from 10 wt % to 40 wt % or from 10 wt % to 25 wt %, or from 12 wt % to 25 wt % carbonate salt. A preferred carbonate salt is sodium carbonate and/or sodium bicarbonate. A highly preferred carbonate salt is sodium carbonate. The carbonate salt, or at least part thereof, is typically in particulate form, typically having a weight average particle size in the range of from 200 to 500 micrometers However, it may be preferred for the carbonate salt, or at least part thereof, to be in micronised particulate form, typically having a weight average particle size in the range of from 4 to 40 micrometers. This is especially preferred when the carbonate salt, or at least part thereof, is in the form of a co-particulate admixture with a non-ionic detersive surfactant.

The composition may comprise high levels of carbonate salt. High levels of carbonate improve the cleaning performance of the composition by increasing the pH of the wash liquor. This increased alkalinity improves the performance of the bleach, if present, increases the tendency of soils to hydrolyse which facilitates their removal from the fabric, and also increases the rate and degree of ionization of the soils to be cleaned; ionized soils are more soluble and easier to remove from the fabrics during the washing stage of the laundering process. In addition, high carbonate levels improve the flowability of the detergent composition when the detergent composition is in free-flowing particulate form.

However, carbonate anions readily complex with calcium cations in the wash liquor to form calcium carbonate. Calcium carbonate is water-insoluble and can precipitate out of solution in the wash liquor and deposit on the fabric in the wash liquor resulting in poor whiteness maintenance. Therefore, it may be preferred if the composition comprises low levels of, or no, carbonate salt. The composition may comprise from 0 wt % to 10 wt % carbonate salt to minimize the negatives associated with the presence of carbonate in the composition. However, as described above in more detail, it may be desirable to incorporate higher levels of carbonate salt in the composition. If the composition comprises high levels of carbonate salt, such as at least 10 wt % carbonate salt, then the composition also preferably comprises an acid source that is capable of undergoing an acid/base reaction with a carbonate anion; the acid source can be sulphamic acid, citric acid, malic acid, succinic acid or any mixture thereof. An especially preferred acid source is sulphamic acid. Preferably, the weight ratio of carbonate salt to the total amount of acid source in the composition that is capable of undergoing an acid/base reaction with a carbonate anion, is preferably less than 50:1, more preferably less than 25:1, or less than 15:1, or less than 10:1 or even less than 5:1.

In order to minimise the undesirable effects of having too high a concentration of carbonate anions in the wash liquor, the total amount of carbonate anion source in the composition is preferably limited. Preferred carbonate anion sources are carbonate salts and/or percarbonate salts. Preferably, the total amount of carbonate anion source (on a carbonate anion basis) in the composition is between 7 wt % to 14 wt % greater than the theoretical amount of carbonate anion source that is required to completely neutralise the total amount of acid source present in the composition that is capable of undergoing an acid/base reaction with a carbonate anion. By controlling the total amount of carbonate anion source in the composition with respect to the amount of acid source in the composition, in the above described manner, all of the benefits of having of a carbonate anion source in the composition are maximised whilst all of the undesirable negative effects of having too high a concentration of carbonate anions in the wash liquor are minimised.

The composition may comprise a sulphate salt. Typically, the composition comprises from 1 wt % to 50 wt % sulphate salt, or from 1 wt % to 30 wt % sulphate salt. A preferred sulphate salt is sodium sulphate. The sulphate salt, or at least part thereof, is typically in particulate form, typically having a weight average particle size in the range of from 60 to 200 micrometers. However, it may be preferred that the sulphate salt, or at least part thereof, is in micronised particulate form, typically having a weight average particle size in the range of from 5 to less than 60 micrometers, preferably from 5 to 40 micrometers. It may even be preferred for the sulphate salt to be in coarse particulate form, typically having a weight average particle size of from above 200 to 800 micrometers.

The composition may preferably comprise less than 60 wt % total combined amount of carbonate and sulphate (such as sodium carbonate and sodium sulphate). The composition may comprise less than 55 wt %, or less than 50 wt %, or less than 45 wt %, or less than 40 wt % total combined amount of carbonate and sulphate(such as sodium carbonate and sodium sulphate).

It may be preferred for the detergent composition to comprise low levels of silicate salt. Preferably, the detergent composition comprises less than 10 wt %, or from 0 wt % to 5 wt %, or less than 4 wt %, or less than 2 wt % silicate salt. It may even be preferred for the detergent composition to be free from silicate salt. Silicate salts include water-insoluble silicates. Silicate salts include amorphous silicates and crystalline layered silicates (e.g. SKS-6). A preferred silicate salt is sodium silicate.

It may be preferred for the composition to comprise at least 1 wt %, or at least 2 wt %, or at least 3 wt %, or at least 4 wt %, or even at least 5 wt % polymeric polycarboxylates. Preferred polymeric polycarboxylates include: polyacrylates, preferably having a weight average molecular weight of from 1,000 Da to 20,000 Da; co-polymers of maleic acid and acrylic acid, preferably having a molar ratio of maleic acid monomers to acrylic acid monomers of from 1: 1 to 1: 10 and a weight average molecular weight of from 10,000 Da to 200,000 Da, or preferably having a molar ratio of maleic acid monomers to acrylic acid monomers of from 0.3:1 to 3:1 and a weight average molecular weight of from 1,000 Da to 50,000 Da.

It may also be preferred for the composition to comprise a soil dispersant having the formula:
bis((C₂H₅O)(C₂H₄O)n)(CH₃)—N⁺—CₓH₂ₓ—N⁺—(CH₃)—bis((C₂H₅O)(C₂H₄O)n)
wherein, n=from 20 to 30, and x=from 3 to 8. Other suitable soil dispersants are sulphonate or sulphated soil dispersants having the formula:
sulphonated or sulphated bis((C₂H₅O)(C₂H₄O)n)(CH₃)—N⁺—CₓH₂ₓ—N⁺—(CH₃)—bis((C₂H₅O)(C₂H₄O)n)
wherein, n=from 20 to 30, and x=from 3 to 8. Preferably, the composition comprises at least 1 wt %, or at least 2 wt %, or at least 3 wt % soil dispersants, typically having the above described formulae.

The composition typically comprises adjunct components. These adjunct components include: bleach such as percarbonate and/or perborate, preferably in combination with a bleach activator such as tetraacetyl ethylene diamine, oxybenzene sulphonate bleach activators such as nonanoyl oxybenzene sulphonate, caprolactam bleach activators, imide bleach activators such as N-nonanoyl-N-methyl acetamide, preformed peracids such as N,N-pthaloylamino peroxycaproic acid, nonylamido peroxyadipic acid or dibenzoyl peroxide; chelants such as diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid); suds suppressing systems such as silicone based suds suppressors; brighteners; photobleach; filler salts; fabric-softening agents such as clay, silicone and/or quaternary ammonium compounds; flocculants such as polyethylene oxide; dye transfer inhibitors such as polyvinylpyrrolidone, poly 4-vinylpyridine N-oxide and/or co-polymer of vinylpyrrolidone and vinylimidazole; fabric integrity components such as hydrophobically modified cellulose and oligomers produced by the condensation of imidazole and epichlorhydrin; soil dispersants and soil anti-redeposition aids such as polycarboxylates, alkoxylated polyamines and ethoxylated ethyleneimine polymers; and anti-redeposition components such as carboxymethyl cellulose and polyesters. Preferably, the composition comprises less than 1 wt % chlorine bleach and less than 1 wt % bromine bleach. Preferably, the composition is free from deliberately added bromine bleach and chlorine bleach.

The composition can be in any granular form such as an agglomerate, a spray-dried power, an extrudate, a flake, a needle, a noodle, a bead, or any combination thereof. Preferably, the detergent composition is in the form of free-flowing particles. The detergent composition in free-flowing particulate form typically has a bulk density of from 450 g/l to 1,000 g/l, preferred low bulk density detergent compositions have a bulk density of from 550 g/l to 650 g/l and preferred high bulk density detergent compositions have a bulk density of from 750 g/l to 900 g/l. During the laundering process, the composition is typically contacted with water to give a wash liquor having a pH of from above 7 to 11, preferably from 8 to 10.5.

The composition may be made by any suitable method including agglomeration, spray-drying, extrusion, mixing, dry-mixing, liquid spray-on, roller compaction, spheronisation or any combination thereof.

In a second embodiment of the present invention, a granular laundry detergent composition is provided, which comprises a detersive surfactant and optionally an enzyme, wherein the composition upon contact with water at a concentration of 9.2 g/1 and at a temperature of 20° C., forms a transparent wash liquor having (i) a turbidity of less than 500 nephelometric turbidity units; and (ii) a pH in the range of from 8 to 12. Preferably, the resultant wash liquor has a turbidity of less than 400, or less than 300, or from 10 to 300 nephelometric turbidity units. The turbidity of the wash liquor is typically measured using a HI 93703 microprocessor turbidity meter. A typical method for measuring the turbidity of the wash liquor is as follows: 9.2 g of composition is added to 1 litre of water in a beaker to form a solution. The solution is stirred for 5 minutes at 600 rpm at 20° C. The turbidity of the solution is then measured using a Hi 93703 microprocessor turbidity meter following the manufacturer's instructions.

### EXAMPLES

### Example 1

Aqueous slurry composition.

| | % w/w |
|---|---|
| | Aqueous |
| Component | slurry |
| A compound having the following general structure: | 1.23 |
| bis((C₂H₅O)(C₂H₄O)n)(CH₃)—N⁺—CₓH₂ₓ—N⁺—(CH₃)— | |
| bis((C₂H₅O)(C₂H₄O)n), wherein n = from 20 to 30, | |
| and x = from 3 to 8, or sulphated or sulphonated | |
| variants thereof | |
| Ethylenediamine disuccinic acid | 0.35 |
| Brightener | 0.12 |
| Magnesium sulphate | 0.72 |
| Acrylate/maleate copolymer | 6.45 |
| Linear alkyl benzene sulphonate | 11.92 |
| Hydroxyethane di(methylene phosphonic acid) | 0.32 |
| Sodium carbonate | 4.32 |
| Sodium sulphate | 47.49 |
| Soap | 0.78 |
| Water | 25.89 |
| Miscellaneous | 0.42 |
| Total Parts | 100.00 |

Preparation of a Spray-dried Powder.

An aqueous slurry having the composition as described above is prepared having a moisture content of 25.89%. The aqueous slurry is heated to 72° C. and pumped under high pressure (from 5.5×10⁶Nm^{31 2}to 6.0×10⁶Nm⁺²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8mm) to form a spray-dried powder, which is free-flowing. Fine material (<0. 15mm) is elutriated with the exhaust the exhaust air in the spray-drying tower and collected in a post tower containment system. The spray-dried powder has a moisture content of 1.0 wt %, a bulk density of 427 g/l and a particle size distribution such that 95.2 wt % of the spray-dried powder has a particle size of from 150 to 710 micrometers. The composition of the spray-dried powder is given below.

Spray-dried powder composition.

| | % w/w |
|---|---|
| | Spray-dried |
| Component | powder |
| A compound having the following general structure: | 1.65 |
| bis((C₂H₅O)(C₂H₄O)n)(CH₃)—N⁺—CₓH₂ₓ—N⁺—(CH₃)— | |
| bis((C₂H₅O)(C₂H₄O)n), wherein n = from 20 to 30, and | |
| x = from 3 to 8, or sulphated or sulphonated variants | |
| thereof | |
| Ethylenediamine disuccinic acid | 0.47 |
| Brightener | 0.16 |
| Magnesium sulphate | 0.96 |
| Acrylate/maleate copolymer | 8.62 |
| Linear alkyl benzene sulphonate | 15.92 |
| Hydroxyethane di(methylene phosphonic acid) | 0.43 |
| Sodium carbonate | 5.77 |
| Sodium sulphate | 63.43 |
| Soap | 1.04 |
| Water | 1.00 |
| Miscellaneous | 0.55 |
| Total Parts | 100.00 |

Preparation of a Non-ionic Detersive Surfactant Particle.

The non-ionic detersive surfactant particle is made on a 25kg batch basis using a Im diameter cement mixer at 24 rpm. 18.9kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C. The mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7)
75.6% w/w sodium sulphate
   Preparation of a Granular Laundrv Detergent Composition in Accordance with the Present Invention.

10.15 kg of the spray-dried powder of example 1, 2.92 kg of the non-ionic detersive surfactant particle of example 1 and 11.93 kg (total amount) of other individually dosed dry-added material are dosed into a Im diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition
in accordance with the present invention.

| | % w/w granular laundry |
|---|---|
| Component | detergent composition |
| Spray-dried powder of example 1 | 40.61 |
| 91.6 wt % active linear alkyl benzene | 2.96 |
| sulphonate flake supplied by | |
| Stepan under the tradename | |
| Nacconol 90G ® | |
| Citric acid | 2.50 |
| Sodium carbonate (coarse grade) | 19.29 |
| Sodium carbonate (micronised grade) | 1.87 |
| Sodium percarbonate (having from 12% to | 13.78 |
| 15% active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate | 4.07 |
| (92 wt % active) | |
| Suds suppressor agglomerate | 0.41 |
| (11.5 wt % active) | |
| Acrylate/maleate copolymer particle | 0.27 |
| (95.7 wt % active) | |
| Green/Blue carbonate speckle | 0.47 |
| Non-ionic detersive surfactant particle | 11.67 |
| of example 1 | |
| Solid perfume particle | 0.63 |
| Total Parts | 100.00 |

### Example 2

Example 1 is repeated except that 6.00% w/w cationic detersive surfactant particle (described in more detail below) is dry-added added and the level of dry-added sodium carbonate is reduced from 19.29% w/w to 13.29% w/w.

Preparation of a Cationic Detersive Surfactant Particle.

The cationic surfactant particle is made on a 14.6 kg batch basis on a Morton FM-50 Loedige. 4.5 kg of micronised sodium sulphate and 4.5 kg micronised sodium carbonate is premixed in the mixer. 4.6 kg of 40% active mono-C₁₂₋₁₄ alkyl mono-hydroxyethyl di-methyl quaternary ammonium chloride (cationic surfactant) aqueous solution is added to the micronised sodium sulphate and micronised sodium carbonate in the mixer whilst both the main drive and the chopper are operating. After approximately two minutes of mixing, a 1.0 kg 1: 1 weight ratio mix of micronised sodium sulphate and micronised sodium carbonate is added to the mixer as a dusting agent. The resulting agglomerate is collected and dried using a fluid bed dryer on a basis of 2500 l/min air at 100-140° C. for 30 minutes. The resulting powder is sieved and the fraction through 1400 μm is collected as the cationic surfactant particle. The composition of the cationic surfactant particle is as follows:
15 % w/w mono-C₁₂₋₁₄ alkyl mono-hydroxyethyl di-methyl quaternary ammonium chloride
40.76% w/w sodium carbonate
40.76% w/w sodium sulphate
3.48% w/w moisture and miscellaneous

### Example 3

Example 1 is repeated except that 2.50% w/w sulphamic acid (mixed grade—supplied by Rhodia) is dry-added instead of 2.50% w/w citric acid.

### Example 4

Example I is repeated except that 1.25% w/w sulphamic acid (mixed grade—supplied by Rhodia) is dry-added, and the level of dry-added citric acid is reduced from 2.5% w/w to 1.25% w/w.

### Example 5

Aqueous slurry composition.

| Component | % w/w Slurry |
|---|---|
| Carboxyl methyl cellulose | 2.52 |
| Brightener | 0.14 |
| Diethylene triamine penta(methyl phosphonic) acid | 0.30 |
| Polymeric polycarboxylate | 4.40 |
| Linear alkyl benzene sulphonate | 16.01 |
| Hydroxyethane di(methylene phosphonic acid) | 0.47 |
| Sodium carbonate | 31.37 |
| Sodium silicate 2.0R | 7.46 |
| Soap | 1.60 |
| Water | 34.00 |
| Miscellaneous | 1.73 |
| Total | 100.00 |

Preparation of a Spray-dried Powder.

An aqueous slurry having the composition as described above is prepared having a moisture content of 34.00%. The aqueous slurry is heated to 72° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1. 8 mm) to form a spray-dried powder, which is free-flowing.

Fine material (<0. 15 mm) is elutriated with the exhaust the exhaust air in the spray-drying tower and collected in a post tower containment system. The spray-dried powder has a moisture content of 1.0 wt %, a bulk density of 440 g/l and a particle size distribution such that 95.2 wt % of the spray-dried powder has a particle size of from 150 to 710 micrometers. The composition of the spray-dried powder is given below.

Spray-dried powder composition.

| | % w/w Spray |
|---|---|
| Component | Dried Granule |
| Carboxyl methyl cellulose | 3.77 |
| Brightener | 0.21 |
| Diethylene triamine penta(methyl phosphonic) acid | 0.45 |
| Polymeric polycarboxylate | 6.61 |
| Linear alkylbenzene sulphonate | 24.02 |
| Hydroxyethane di(methylene phosphonic acid) | 0.71 |
| Sodium carbonate | 47.04 |
| Sodium silicate 2.0R | 11.18 |
| Soap | 2.41 |
| Water | 1.00 |
| Miscellaneous | 2.60 |
| Total Parts | 100.00 |

Preparation of a Granular Laundry Detergent Composition in Accordance with the Present Invention.

10.61 kg of the spray-dried powder and 13.74 kg (total amount) of other individually dosed dry-added material are dosed into a Im diameter concrete batch mixer operating at 24 rpm. Following the addition of these dry materials, 0.54 kg of C₁₄₋₁₅ ethoxylated alkyl alcohol having an average degree of ethoxylation of 7 (AE7) is applied to the mixture by spraying. Following this, 0.1 kg of perfume is applied by spraying. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition
in accordance with the present invention.

| | % w/w granular |
|---|---|
| | laundry detergent |
| Component | composition |
| Spray dried powder of example 5 | 42.55 |
| Suds suppressor agglomerate (11.5% active) | 2.50 |
| Citric acid | 0.93 |
| Percarbonate (having from 12% to 15% active AvOx) | 14.21 |
| Sodium sulphate | 27.28 |
| Amylase (21.55 mg active/g) | 0.63 |
| Protease (56.00 mg active/g) | 0.36 |
| Tetraacetyl ethylene diamine agglomerate | 2.59 |
| (92 wt % active) | |
| Cellulase (2.3 mg active/g) | 0.15 |
| Blue carbonate speckle | 2.00 |
| C₁₄₋₁₅ ethoxylated alkyl alcohol having an | 2.17 |
| average degree of ethoxylation of 7 (AE7) | |
| Blue phosphate speckle | 4.19 |
| Perfume | 0.44 |
| Total Parts | 100.00 |

### Example 6

Example 5 is repeated except that 0.93% w/w sulphamic acid (mixed grade—supplied by Rhodia) is dry-added instead of 0.93% citric acid

### Example 7

Aqueous slurry composition.

| Component | % w/w Aqueous slurry |
|---|---|
| Ethylenediamine disuccinic acid | 0.40 |
| Brightener | 0.13 |
| Magnesium sulphate | 0.83 |
| Acrylate/maleate copolymer | 7.42 |
| Cationic surfactant | 3.57 |
| Hydroxyethane di(methylene phosphonic acid) | 0.37 |
| Sodium sulphate | 44.67 |
| Sodium chloride | 10.63 |
| Soap | 0.90 |
| Water | 29.81 |
| Miscellaneous | 1.26 |
| Total Parts | 100.00 |

Preparation of a Sprav-dried Powder.

An aqueous slurry having the composition as described above is prepared having a moisture content of 29.81%. The aqueous slurry is heated to a temperature of from 65° C. to 80° C. and pumped under high pressure (from 5.5×10⁶Nm⁻² to 6.0×10⁶Nm⁻²), into a counter current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0. 15 mm) is elutriated with the exhaust air in the spray-drying tower and collected in a post tower containment system. The composition of the resultant spray-dried powder is described below.

Spray-dried powder composition.

| | % w/w |
|---|---|
| Component | Spray-dried powder |
| Ethylenediamine disuccinic acid | 0.57 |
| Brightener | 0.19 |
| Magnesium sulphate | 1.17 |
| Acrylate/maleate copolymer | 10.47 |
| Cationic surfactant | 5.03 |
| Hydroxyethane di(methylene phosphonic acid) | 0.52 |
| Sodium sulphate | 63.00 |
| Sodium chloride | 15.00 |
| Soap | 1.27 |
| Water | 1.00 |
| Miscellaneous | 1.78 |
| Total Parts | 100.00 |

Preparation of a Non-ionic Detersive Surfactant Particle

The non-ionic detersive surfactant particle is made on a 25 kg batch basis using a 1 m diameter cement mixer at 24 rpm. 18.9 kg light grade sodium sulphate supplied by Hamm Chemie under the tradename Rombach Leichtsulfat® is added to the mixer and then 6.1 kg C₁₄₋₁₅ ethoxylated alkyl alcohol having an average degree of ethoxylation of 7 (AE7) in liquid form is sprayed onto the sodium sulphate at 40° C. The mixture is mixed for 3 minutes to produce the non-ionic detersive surfactant particle, which is free flowing. The composition of the non-ionic detersive surfactant particle is as follows:
24.4% w/w C₁₄₋₁₅ ethoxylated alkyl alcohol having an average degree of ethoxylation of 7 (AE7)
75.6% w/w sodium sulphate
   Preparation of an Anionic Detersive Surfactant Particle.

The linear alkyl benzene sulphonate particle is made on a 14 kg batch basis on a Morton FM-50 Loedige. 7.84 kg micronised sodium sulphate and 2.70 kg micronised sodium carbonate are first added to the mixer while the main drive and chopper are operating. Then 3.46 kg linear alkyl benzene sulphonate paste (78 wt % active) is added to the mixer and mixed for 2 minutes to produce a mixture. The resulting mixture is collected and dried using a fluid bed dryer on a basis of 2500 l/min air at 100-140° C. for 30 minutes to produce the anionic detersive surfactant particle. The composition of the anionic detersive surfactant particle is as follows:
20% w/w linear alkyl benzene sulphonate
20% w/w sodium carbonate
58% w/w sodium sulphate
2% w/w miscellaneous and water
   Preparation of a Granular Laundry Detergent Composition in Accordance with the Present Invention.

10.15 kg of the spray-dried powder of example 9, 2.26 kg of the non-ionic detersive surfactant particle of example 9, 8.5 kg of the anionic detersive surfactant particle of example 9 and 4.09 kg (total) of other individually dosed dry-added material are dosed into a 1 m diameter concrete batch mixer operating at 24 rpm. Once all of the materials are dosed into the mixer, the mixture is mixed for 5 minutes to form a granular laundry detergent composition in accordance with the present invention. The formulation of the granular laundry detergent composition in accordance with the present invention is described below.

A granular laundry detergent composition
in accordance with the present invention.

| | % w/w granular |
|---|---|
| | laundry detergent |
| Component | composition |
| Spray dried powder of example 9 | 40.11 |
| Sulphamic acid (mixed grade) supplied by Rhodia | 2.50 |
| Percarbonate (having from 12% to 15% active AvOx) | 7.22 |
| 91.6 wt % active linear alkyl benzene sulphonate | 2.00 |
| flake supplied by Stepan under the tradename | |
| Nacconol 90G ® | |
| Lipase (11.00 mg active/g) | 0.70 |
| Amylase (21.55 mg active/g) | 0.33 |
| Protease (56.00 mg active/g) | 0.43 |
| TAED agglomerate (92% active) | 1.70 |
| Suds suppressor agglomerate (11.5% active) | 0.55 |
| Acrylate/maleate copolymer particle (95.7% active) | 0.89 |
| Anionic detersive surfactant particle of example 9 | 34.00 |
| Non-ionic detersive surfactant particle of example 9 | 9.05 |
| Solid perfume particle | 0.52 |
| Total Parts | 100.00 |

All documents cited in the detailed description of the invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A granular laundry detergent composition comprising:
(i) from 8 wt % to 55 wt % anionic detersive surfactant; and
(ii) from 2 wt % to 8 wt % non-ionic detersive surfactant; and
(iii) from 0 wt % to 4 wt % zeolite builder; and
(iv) from 0 wt % to 4 wt % phosphate builder; and
(v) optionally an enzyme.

2. A composition according to claim 1, wherein the composition comprises:
(i) protease in an amount of at least 11 mg active protease per 100 g of the composition; and
(ii) lipase in an amount of at least 5 mg active lipase per 100 g of the composition,
wherein the weight ratio of protease to lipase is at least 1.5:1.

3. A composition according to claim 1, wherein the composition is in free-flowing particulate form, the composition comprises:
(i) protease in an amount of at least 11 mg active protease per 100 g of the composition; and
(ii) amylase in an amount of at least 4 mg active amylase per 100 g of the composition,
wherein the weight ratio of protease to amylase is in the range of from 1.5:1 to 2.3:1.

4. A composition according to claim 1, wherein the composition comprises:
(i) protease in an amount of at least 11 mg active protease per 100 g of the composition; and
(ii) amylase in an amount of at least 4 mg active amylase per 100 g of the composition,
wherein the weight ratio of protease to amylase is at least 3.1:1.

5. A composition according claim 1, wherein the composition comprises:
(i) from 6 wt % to 12 wt % anionic detersive surfactant; and
(ii) from 4 wt % to 6 wt % non-ionic detersive surfactant,
wherein at least part of the anionic detersive surfactant and at least part of the non-ionic detersive surfactant are in the form of a co-particulate admixture, wherein the co-particulate admixture is in spray-dried powder form.

6. A composition according to claim 1, wherein the composition comprises:
(i) from 10 wt % to 16 wt % linear alkyl benzene sulphonate; and
(ii) from 2 wt % to 4 wt % non-ionic detersive surfactant, and (iii) soap,
wherein at least part of the linear alkylbenzene sulphonate is in a co-particulate admixture with soap, the co-particulate admixture of linear alkyl benzene sulphonate and soap is in spray-dried form, and wherein at least part of the non-ionic detersive surfactant is the form of a co-particulate admix with soap, the co-particulate admix of non-ionic detersive surfactant and soap is in non-spray-dried form.

7. A composition according to claim 1, wherein the composition comprises from 0 wt % to 10 wt % carbonate salt.

8. A composition according to claim 1, wherein the composition comprises:
(i) at least 10 wt % carbonate salt; and
(ii) an acid source that is capable of undergoing an acid/base reaction with a carbonate anion,
wherein the weight ratio of carbonate salt to acid source is less than 15:1.

9. A composition according to claim 1, wherein the composition comprises:
(i) a carbonate anion source; and
(ii) an acid source that is capable of undergoing an acid/base reaction with a carbonate anion,
wherein the total amount of carbonate anion source, on a carbonate anion basis, in the composition is between 7 wt % to 14 wt % greater than the theoretical amount of carbonate anion source that is required to completely neutralise the total amount of acid source present in the composition that is capable of undergoing an acid/base reaction with a carbonate anion.

10. A composition according to claim 1, wherein the composition comprises from 0 wt % to 5 wt % silicate salt.

11. A composition according to claim 1, wherein the composition comprises at least 2 wt % polymeric polycarboxylate.

12. A composition according to claim 1, wherein the composition is free from zeolite builder.

13. A composition according to claim 1, wherein the composition is free from phosphate builder.

14. A composition according to claim 1, wherein the composition comprises from 0.5 wt % to 6 wt % cationic detersive surfactant.

15. A composition according to claim 1, wherein the composition comprises a soil dispersant having the formula:
bis((C₂H₅O)(C₂H₄O)n)(CH₃)—N³⁰ —CₓH₂ₓ—N³⁰ —(CH₃)—bis((C₂H₅O)(C₂H₄O)n)
wherein, n=from 20 to 30, and x=from 3 to 8.

16. A composition according to claim 1, wherein the composition comprises a soil dispersant having the formula:
sulphonated or sulphated bis((C₂H₅O)(C₂H₄O)n)(CH₃)—N⁺—CₓH₂ₓ—N⁺—(CH₃)—bis((C₂H₅O)(C₂H₄O)n)
wherein, n=from 20 to 30, and x=from 3 to 8.

17. A composition according to claim 1, wherein the composition comprises at least 2 wt % of a soil dispersant.

18. A composition according to claim 1, wherein the composition comprises sulphamic acid and/or water-soluble salts thereof.

19. A composition according to claim 1, wherein at least part of the anionic detersive surfactant is in extrudate form.

20. A composition according to claim 1, wherein at least part of the anionic detersive surfactant is in agglomerate form.

21. A composition according claim 1, wherein at least part of the non-ionic detersive surfactant is in spray-dried powder form.

22. A composition according to claim 1, wherein the composition is in free-flowing particulate form.

23. A granular laundry composition comprising a detersive surfactant and optionally an enzyme, wherein the composition upon contact with water at a concentration of 9.2 g/l and at a temperature of 20° C., forms a transparent wash liquor having:
(i) a turbidity of less than 500 nephelometric turbidity units; and
(ii) a pH in the range of from 8 to 12.
